(19) United States
(12) Patent Application Publication
(10) Pub. No.: US 2012/0311015 A1
(43) Pub. Date: Dec. 6, 2012

(54) SYSTEM AND METHOD FOR EXECUTING COMPLEX OPERATIONS IN DYNAMIC SESSION CONTEXT

(76) Inventor: Asaf GANOT, Ra'anana (IL)

(21) Appl. No.: 13/118,941

(22) Filed: May 31, 2011

(51) Int. Cl. G06F 15/16

(52) U.S. Cl. 709/202

(57) ABSTRACT

A method for executing operations in a user session context comprising: requesting execution of an operation in a remote machine, by an agent software component installed on the remote machine, the operation requires a task within a user session running on the remote machine; connecting between the user session and the agent software component for communication of task instructions; and performing within the user session task instructions accessible by the agent software component, wherein the connection between the user session and the agent software component is ceased once the task instructions are completed.

### BACKGROUND OF THE INVENTION

There are some known methods that provide remote access to remote computers and remote control of remote computers. These methods usually require a running, pre-installed agent component that constantly runs within sessions of users in multiple controlled remote computers. Additionally, in known methods which enable access to a user session in a remote computer from a managing console, there is a requirement to grant general security permissions to the operator of the managing console over private content of users.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for executing complex operations in dynamic session context according to embodiments of the present invention;

FIG. 2 is a schematic flowchart illustrating a method for executing complex operations in dynamic session context according to embodiments of the present invention;

FIG. 3 is a schematic flowchart illustrating a method for inspecting the request for operation according to embodiments of the present invention;

FIG. 4 is a schematic flowchart illustrating a method for pre-operation installation according to embodiments of the present invention; and

FIG. 5 is a schematic illustration of an exemplary method for executing complex operations in dynamic session context according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

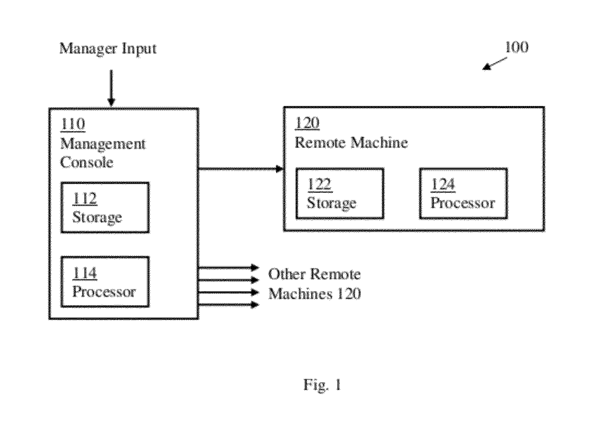

Reference is now made to FIG. 1, which is a schematic illustration of a system 100 for executing complex operations in dynamic session context according to embodiments of the present invention. System 100 may include a management console 110, such as, for example, a central server or workstation, and a plurality of remote user machines 120, such as, for example, a plurality of remote workstations, which may be used by multiple users for independent tasks. Each if user machines 120 include a storage medium 122 and a processor 124, by which a remote machine 120 may run in various time slots various user sessions, for example in accordance to the user's usage of the machine 120. Management console 110 may include a storage medium 112 and a processor 114. Machines 120 may be managed, controlled and/or supervised by management console 110. Management console 110 and machines 120 may communicate by a wired or wireless connection and/or by any suitable communication devices and/or communication protocols.

Management console 110 and user machine 120 may perform operations according to embodiments of the present invention, as described in detail herein. Each of management console 110 and remote machine 120 may include a general purpose computer and/or may be selectively activated or reconfigured by computer programs stored in management console 110 and/or remote machine 120. Such computer programs may be stored in storage medium 112 and/or storage medium 122. Each of storage medium 112 and storage medium 122 may include a non-transitory computer readable storage medium, such as, but is not limited to, any type of disk including floppy disks, optical disks, CD-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions, and capable of being coupled to a computer system bus. Each of storage medium 112 and storage medium 122 may include a processor readable storage medium readable by processor 114 and/or processor 124, such as for example a memory, a disk drive, or a USB flash memory, which may encode, include or store instructions, e.g., computer-executable instructions, which when executed by processor 114 or processor 124, cause processor 114 or processor 124 to carry out methods according to embodiments of the present invention disclosed herein. For example, the instructions may cause processor 114 or processor 124 to execute processes that carry out methods according to embodiments of the present invention disclosed herein.

According to embodiments of the present invention, a controller of machines 120, such as, for example, a manager or administrator of a computer network, or a service provider of a computer network, may perform operations in a machine 120 via management console 110. An operation according to embodiments of the present invention may include multiple steps in various levels of remote machine 120 and/or the user session that may run on the machine. As described in detail herein, embodiments of the present invention may enable access via management console 110 to a running user session on remote machine 120, and thus, for example, may enable access to and/or alteration of data and/or settings within the running session, control of the running session and/or code execution within the running session, without requiring a running, pre-installed agent code within the session's context.

According to embodiments of the present invention, management console 110 may receive input from the controller and run an agent code with corresponding instructions on a remote machine 120, wherein upon necessity of access to the user session, a relevant instruction code included in the agent code may be communicated and/or run on the user session. According to the instruction code, a required task in the user session may be executed. When the task is completed, the instruction code may cease running in the user session. Thus, an access to a user session is enabled without requiring an agent code that constantly runs within the user session or otherwise preinstalled.

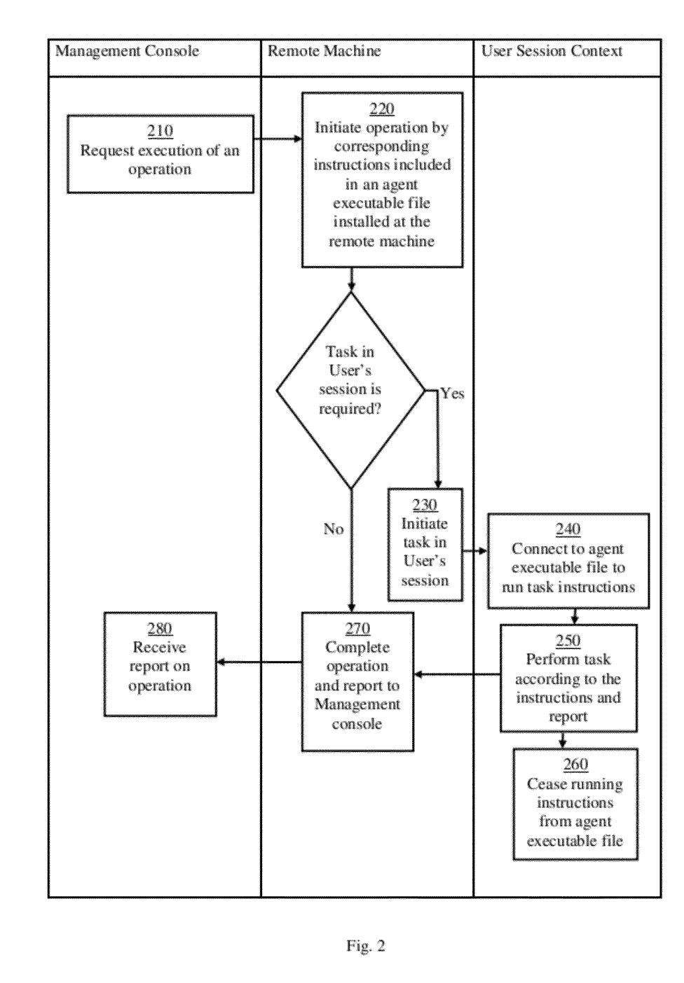

Reference is now made to FIG. 2, which is a schematic flowchart illustrating a method for executing complex operations in dynamic session context according to embodiments of the present invention. As indicated in block 210, the method may include requesting execution of an operation, the request to execute an operation may be sent from management console 110 to remote machine 120, for example according to input received from a controller. For example, the request received from console 110 may include a command to run operation-specific instructions included in or accessible by an agent software component installed and/or running on remote machine 120, and/or stored on remote machine 120 as, for example, a plug-in, Dynamic Link Library (DLL) and/or similar collection of instructions accessible by the agent software component. The agent software component on remote machine 120 may include an executable file and/or a collection of codes and/or computer programs and/or parameters, which may be accessed by management console 110 for execution of operations on remote machine 120 and communication of data, commands and/or requests between management console 110 and remote machine 120. According to embodiments of the present invention described herein, the operation-specific instructions may be written, for example in advance, to remote machine 120 and/or to an agent software component installed and/or running on remote machine 120. Alternatively, the agent software component and/or the operation-specific instructions may be installed and/or running on remote machine 120, for example upon, just before, or as part of the request for operation from console 110, for example based on the input received from the controller. As indicated in block 220, the method may include initiating the requested operation by remote machine 120, according to the corresponding operation-specific instructions included in and/or accessible by the agent software component installed and/or running on remote machine 120.

The requested operation may require access into a running user session on remote machine 120, e.g. activities performed on remote machine 120 by a user. The access into the user session may be required, for example, for execution of tasks in the user session under the user's security context, such as obtainment and/or alteration of data arid/or settings within the running session, management of the running session and/or code execution within the running session. In case a task is needed to be performed within a running user session, as indicated in block 230, the method may include initiating task in a user session, for example a task required according to the operation-specific instructions included and/or accessible by the agent software component installed and/or running on remote machine 120. In order to permit access to the user session, the initiation of the task in the user session may include, for example, execution of authentication of the controller/manager of console 110, which may enable access to the user session. The authentication may require identification and/or authorization information of the controller/manager of console 110, such as, for example, a user name, password, key code and/or supplemental identification information and/or information about the controller of console 110. The task initiation may also include indication of request of the required task, for example by indication of a unique identifier of the task, such as, for example, a task instance identifier such as a Globally Unique Identifier (GUID) of the task. As indicated in block 240, upon task initiation, the method may include connecting between the user session and the agent software component for communication of task specific instructions. As indicated in block 250, the method may include performing the task in the user session according to the instructions and reporting the task results to the agent software component installed and/or running on remote machine 120. The task specific instructions may run as a software component within the user session and/or cause execution of a software component within the user session. Obtained data and/or requests from the user session, for example that result from the performed task, may be communicated to the agent component. As indicated in block 260, once the task is completed, the instructions from the agent software component complete and/or cease running in the user session, and therefore, for example, the connection between the user session and the agent software component cease. Thus, for example, the user session may continue as may be required by the user, without having the agent software component running within the session.

As indicated in block 270, once the results of the task performed in the user session are received into the agent software component installed and/or running on remote machine 120, machine 120 may complete the requested operation as may be required according to operation-specific instructions and report the operation results to management console 110, the operation results may include, for example, requested data from the user session and/or report on operations/tasks performed within the user session. As indicated in block 280, management console 110 may receive the operation report and store and/or use the data included in the report, for example, according to input from the controller of management console 110.

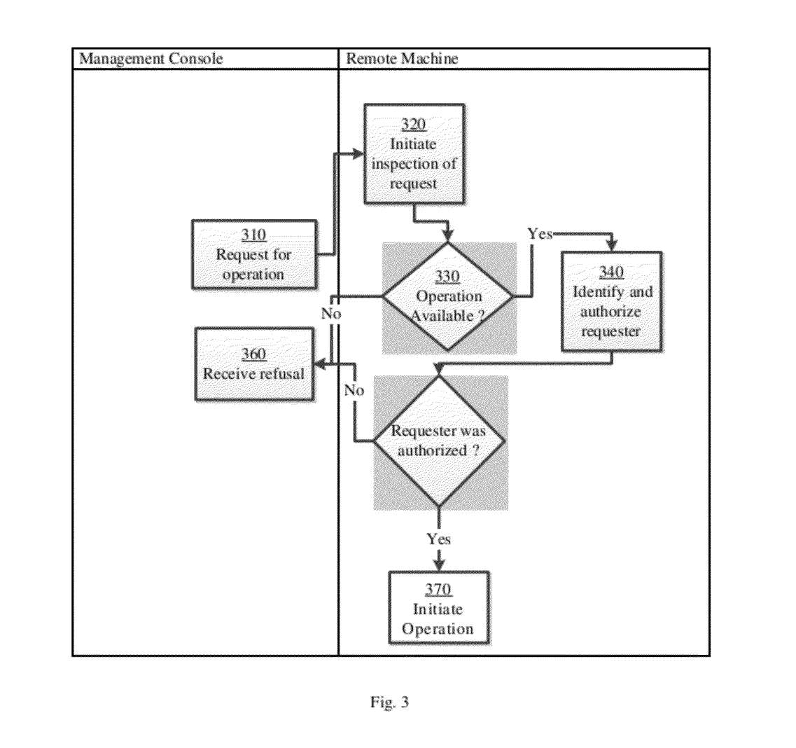

When a request for operation is received by remote machine 120, a number of inspection operations are performed by remote machine 120 before initiating the operation. Reference is now made to FIG. 3, which is a schematic flowchart illustrating a method for inspecting the request for operation according to embodiments of the present invention. As indicated in block 310, a request for operation may be sent from management console 110 to remote machine 120. As indicated in block 320, an inspection of the response may be initiated by remote machine 120. As indicated in block 330, remote machine 120 may inspect whether the operation is available, e.g. whether a corresponding agent software component and/or operation code in and/or accessible by an agent software component is available. For example, remote machine 120 may inspect whether corresponding operation-specific instructions are included in an agent software component installed on machine 120, and/or whether such instructions are stored on machine 120 and/or accessible by the agent software component. As indicated in block 340, remote machine 120 may inspect whether the requester, e.g. management console 110 and/or its controller, can be identified and authorized. For example, remote machine 120 may require a certain identification and/or authentication code that may, for example, be included in the request for operation or be requested separately by remote machine 120. In case the operation is found not available in block 330 and/or the requester cannot be identified and/or authorized in block 340, remote machine 120 may refuse the request for operation. Accordingly, as indicated in block 360, management console 110 may receive a refusal massage from remote machine 120. In case the operation is found available in block 330 and the requester is identified and authorized in block 340, the operation may be initiated, as indicated in block 370, and may proceed as described herein, for example, with reference to FIGS. 2 and/or 5.

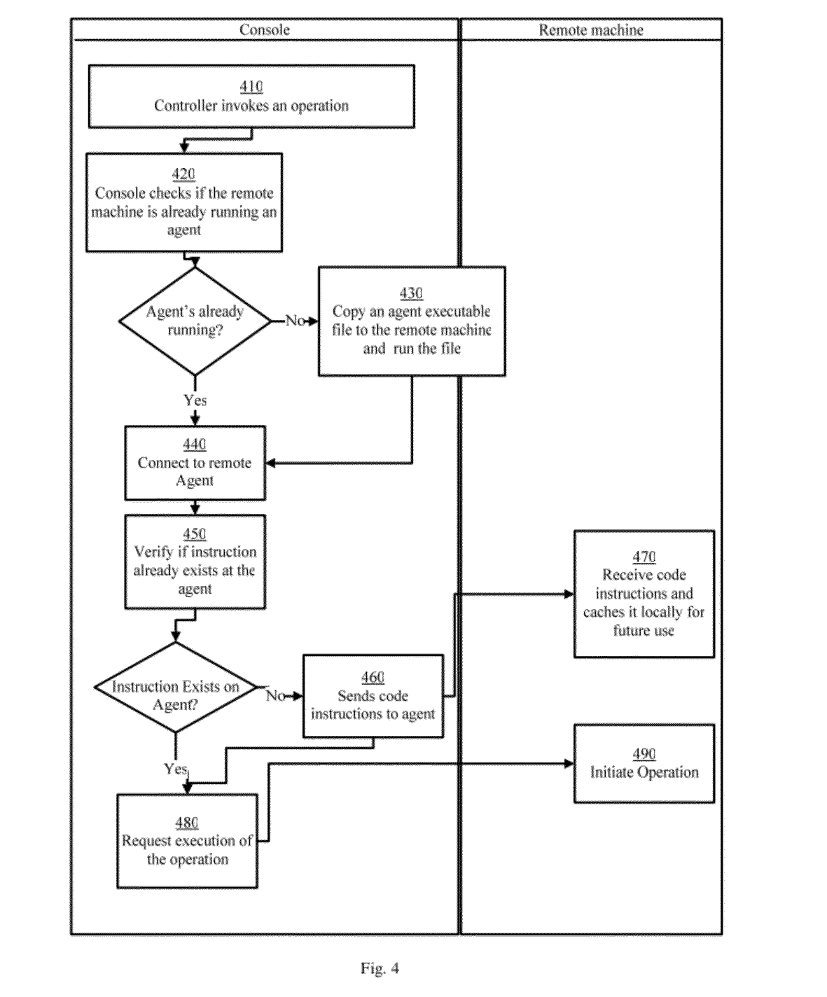

As described above, in embodiments of the present invention an operation may be initiated and/or executed in remote machine 120 according to operation-specific instructions that may be included in and/or accessible by an agent software component installed on machine 120. Therefore, in order to initiate an operation in machine 120, for example upon input from the controller, console 110 may perform a pre-operation installation procedure in order to verify that a corresponding agent component and/or operation-specific instructions exist in machine 120. Reference is now made to FIG. 4, which is a schematic flowchart illustrating a method for pre-operation installation (whether short or long term) according to embodiments of the present invention. It will be appreciated that the term installation and any inflection of the word install throughout the present specification is not limited to permanent installation and may refer to temporal, short term or long term installation. As indicated in block 410, an operation may be invoked, for example, by a controller of console 110, e.g. by a command to perform an operation in machine 120. As indicated in block 420, upon invocation of an operation, console 110 may check whether a suitable agent software component is running on remote machine 120, for example, by contacting remote machine 120 and/or by looking for an existing connection with a suitable agent software component. In case there is no suitable agent software component running on remote machine 120, as indicated in block 430, a suitable agent software component may be copied, installed and/or ran on remote machine 120 by console 110. In some cases, if required, a suitable software component may be first generated by console 110, and then be copied to remote machine 120. Once a suitable agent software component is running on remote machine 120, as indicated in block 440, console 110 may connect to the agent, or alternatively wait for connection from the agent software component. As described in detail herein, the agent software component may intermediate between management console 110 to a software component running within the session of a user running on user machine 120, and thus, for example, may enable access from management console 110, via the agent software component, to the running user session, including, for example, access and/or alteration of data and/or settings under the security context of the user within the running session, control of the running session and/or code execution within the running session, without requiring a running, pre-installed agent code within the session.

As indicated in block 450, console 110 may check whether suitable operation-specific code instructions, which correspond to the operation invoked by the controller of console 110, exist in the agent software component, and/or exist on machine 120 and/or accessible by the agent component. In case there are no suitable operation-specific code instructions in the agent component and/or on machine 120, as indicate in block 460, console 110 may send the suitable code instructions to the agent component and/or machine 120. As indicated in block 470, the agent component installed and/or running on machine 120 may receive the code instructions and, for example, cache the instructions on machine 120 for future use. As indicated in block 480, once suitable operation-specific code instructions, which correspond to the operation invoked by the controller of console 110, exist in and/or accessible by the agent software component, console 110 may send to machine 120 a request to execute the operation. In some cases, if required, the request may include some operation and/or execution parameters and/or any other suitable complementary data that may be required for execution of the operation by machine 120. As indicated in block 490, once a request is received from console 110, machine 120 may initiate the operation by the suitable operation-specific code instructions existing in and/or accessible by the agent software component. In some embodiments of the present invention, before the operation is initiated, an inspection of the request is performed, for example as described herein with reference to FIG. 3.

In some embodiments of the present invention, the agent software component, may be installed on remote machine 120 temporarily, e.g. for execution of a certain operation or set of operations, and then, for example, may be revoked, uninstalled and/or removed from remote machine 120, after the certain operation or set of operations and/or additional required related tasks are completed. In some embodiments, the removal of the agent component from machine 120 may be performed automatically by machine 120 once the required operations and/or tasks are completed. For example, in some embodiments of the present invention, the agent software component may include instructions to revoke the agent software components and/or relevant configuration in case it is no longer necessary.

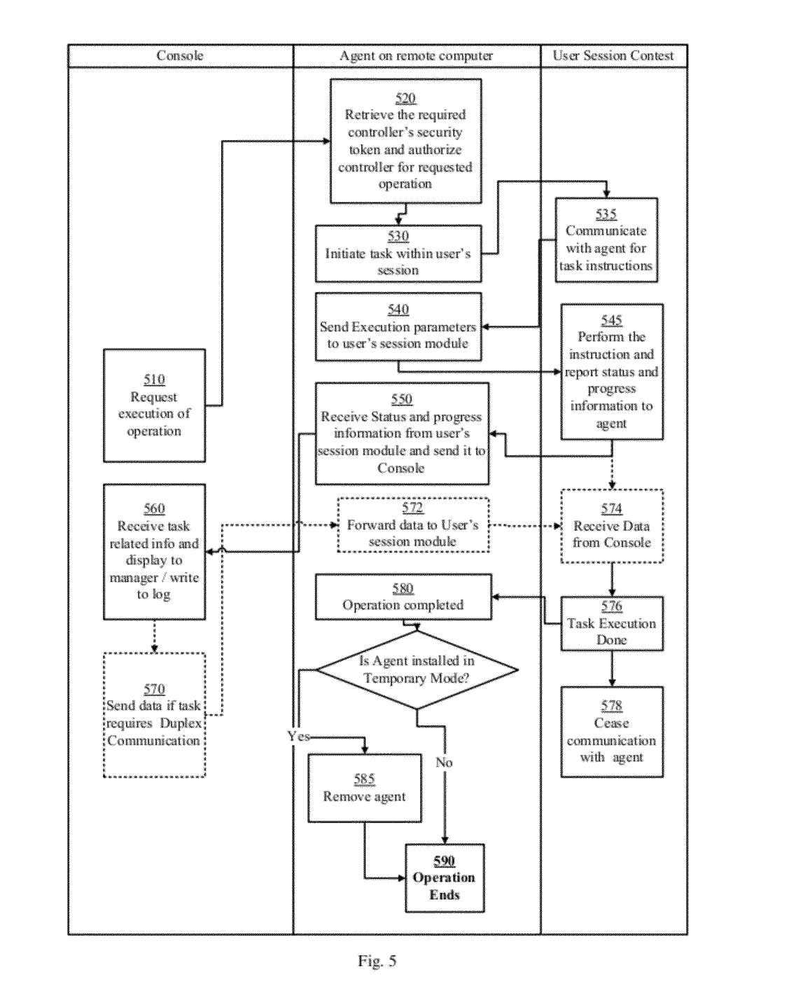

Reference is now made to FIG. 5, which is a schematic illustration of an exemplary method for executing complex operations in dynamic session context according to embodiments of the present invention. As indicated in block 510, management console 110 may send a request for execution of an operation, for example, of certain instructions in and/or accessible by the agent software component installed on remote machine 120, as described in detail herein above. The requested operation may include, according to embodiments of the present invention, performance of tasks within the user session context, as described in detail herein. A non-exhaustive list of such possible tasks may include, for example: activation of full duplex pop-up messages to users, retrieval of a screen shot on demand, providing of support to end users, sending of remote support invitations on behalf of a user, access to and/or manipulation of environment variables, running of processes and/or execution of commands within a user session, etc. As described in detail herein, embodiments of the present invention enable performance of such and other tasks within a live user session or on an unattended computer, without running pre-installed agents in all sessions of users in the various remote machines 120, and without running a pre-installed agent on each machine 120, and without a need to provide the controller of console 110, such as the system administrator, manager and/or service provider, general security rights over private content which is accessible via the user the session.

As indicated in block 520, upon the request, remote machine 120 may authorize the controller of console 110, for example, for execution of the requested operation. The authorization may include retrieval and/or creation of a security token of the controller of console 110. The security token of the controller of console 110 may include, for example, identification information such as, for example, a user name, password, key code and/or may be used for deduction of authorization information of the controller in regards to the requested operation. The security token may be issued once upon connection between the management console 110 and the remote machine 120, and/or may be stored for future use, e.g. future operations and tasks requested by the controller of console 110, or it may be issued specifically upon an individual task request. The security token may include/enable permissions for all tasks or for certain tasks, for example in a certain level of security or under a certain limitation of security. Alternatively, the security token may include/enable permissions for a specific task or specific kind of tasks. As indicated in block 530, remote machine 120 may initiate the task within the user session by initiation of execution within the user session of a software component, such as the agent software component itself and/or another software component accessible by the agent component. The initiation may include, for example, providing a unique identifier of the task request.

As indicated in blocks 535 and 540, once the task is initiated, the agent component running on machine 120 and the software component running within the user session may connect and communicate details, execution instructions, and/or parameters of the task to be performed within the user session. As indicated in block 545, the task may be performed within the user session, for example as a software component within the user session, and/or cause execution of a software component within the user session. Obtained data and/or requests from the user session, for example that result from the performed task, may be communicated to the agent component. Information about the task execution such as, for example, status, progression and/or results of the task may be reported from the user session module to the controller via the agent component during and/or after execution of the task. As indicated in block 550, the reported task results, status and/or progression may be reported by the agent component to management console 110. As indicated in block 560, management console 110 may receive any task-related information and/or information about the task execution such as, for example, status, progression and/or results of the task, and display the information to the manager/controller of management console 110. Additionally, the received task-related information may be written to an operations log stored on console 110, for example on storage medium 112.

In some embodiments of the present invention, the requested task performed within the user session may require duplex communication with management console 110 for data and/or further instructions. In such cases, as indicated in block 570 management console 110 may send to the agent component the required data and/or instructions, for example, based upon the received task-related information. As indicated in blocks 572 and 574, the data and/or instructions may be communicated by the agent software component to the user session module. The duplex communication with similar communication rounds may continue, for example until the task may be completed and/or no additional data and/or instructions are required.

As indicated in blocks 576 and 578, after the task is completed based on the task instructions received from the agent component, the instructions from the agent software component complete and/or cease running in the user session, and therefore, for example, the connection between the user session and the agent software component cease. Thus, for example, the user session may continue as may be required by the user, without having the agent software component continue running within the session. As indicated in block 580, once the task is completed, machine 120 may complete the operation requested by console 110, for example, based on operation-specific instructions in and/or accessible by the agent component as described herein.

A mentioned above, in some embodiments of the present invention, the agent software component is installed on remote machine 120 temporarily, e.g. to enable execution of a certain operation or set of operations, and then, for example, may be revoked, uninstalled and/or removed from remote machine 120, after the certain operation or set of operations and/or additional required related tasks are completed. Accordingly, as indicated in block 585, in case the agent software component is installed on machine 120 in a temporal mode, the agent component may be removed from machine 120, and thus, for example, ending the operation as indicated in block 590. The agent component may be removed from machine 120 by, for example, creating a script file to remove the agent component from machine 120. In some embodiments of the present invention, for example, the agent software component may include instructions to revoke the file once the requested operation is completed. In case the agent software component is installed on machine 120 not in a temporal mode, the operation may end as indicated in block 590 without removing the agent component, for example once the operation-specific instructions in and/or accessible by the agent component are completed.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for executing operations in a user session context comprising:
requesting execution of an operation in a remote machine, by an agent software component installed on the remote machine, the operation requires a task within a user session running on the remote machine;
connecting between the user session and the agent software component for communication of task instructions; and
performing within the user session task instructions accessible by the agent software component, wherein the connection between the user session and the agent software component is ceased once the task instructions are completed.

2. The method according to claim 1, wherein the agent software component is pre-installed in the remote machine.

3. The method according to claim 1, wherein the agent software component is installed temporarily, to enable execution of the operation once the operation is requested, and removed from the remote machine once the operation is completed.

4. The method according to claim 1, wherein the request for execution of operation is inspected before connecting between the user session and the agent software component, for at least on of authorizing the requester and checking whether corresponding instructions are accessible by the agent software component.

5. The method according to claim 1, wherein the connection between the user session and the agent software component is obtained by initiating execution within the user session of a software component and providing identification of the task request.

6. The method according to claim 5, wherein once the connection between the user session and the agent software component is obtained, details of the task to be performed within the user session are communicated to the user session.

7. The method according to claim 1, wherein information about the task execution are reported by the agent software component to a management console.

8. The method according to claim 7, wherein performing the task includes duplex communication with said management console.

9. The method according to claim 1, wherein the connection between the user session and the agent software component is obtained by authorizing a controller of a management console for execution of the requested operation.

10. The method according to claim 5, wherein the software component executed within the user session is at least one of the agent software component itself and another software component accessible by the agent software component.

11. A non-transitory processor-readable storage medium having instructions stored thereon that, when executed by a processor, result in:
requesting execution of an operation in a remote machine, by an agent software component installed on the remote machine, the operation requires a task within a user session running on the remote machine;
connecting between the user session and the agent software component for communication of task instructions; task instructions; and
performing within the user session task instructions accessible by the agent software component, wherein the connection between the user session and the agent software component is ceased once the task instructions are completed.

12. The storage medium having instructions stored thereon according to claim 11, wherein the agent software component is pre-installed in the remote machine.

13. The storage medium having instructions stored thereon according to claim 11, wherein the agent software component is installed temporarily, to enable execution of the operation once the operation is requested, and removed from the remote machine once the operation is completed.

14. The storage medium having instructions stored thereon according to claim 11, wherein the request for execution of operation is inspected before connecting between the user session and the agent software component, for at least one of authorizing the requester and checking whether corresponding instructions are accessible by the agent software component.

15. The storage medium having instructions stored thereon according to claim 11, wherein connection between the user session and the agent software component is obtained by initiating execution within the user session of a software component and providing identification of the task request.

16. The storage medium having instructions stored thereon according to claim 15, wherein once connection between the user session and the agent software component is obtained, details of the task to be performed within the user session are communicated to the user session.

17. The storage medium having instructions stored thereon according to claim 11, wherein information about the task execution are reported by the agent software component to a management console.

18. The storage medium having instructions stored thereon according to claim 17, wherein performing the task includes duplex communication with said management console.

19. The storage medium having instructions stored thereon according to claim 11, wherein the connection between the user session and the agent software component is obtained by authorizing a controller of a management console for execution of the requested operation.

20. The storage medium having instructions stored thereon according to claim 15, wherein the software component executed within the user session is at least one of the agent software component itself and another software component accessible by the agent software component.
